(19) United States
(12) Patent Application Publication
(10) Pub. No.: US 2017/0102670 A1
(43) Pub. Date: Apr. 13, 2017

(54) INTEGRATED HANDLE AND LATCH FOR A REPLACEABLE UNIT OF AN ELECTROPHOTOGRAPHIC IMAGE FORMING DEVICE

(71) Applicant: LEXMARK INTERNATIONAL, INC., LEXINGTON, KY (US)

(72) Inventors: DARREN WAYNE TOSH, LEXINGTON, KY (US); DAVID FRANCIS CARTER, MOUNT STERLING, KY (US)

(21) Appl. No.: 15/249,662

(22) Filed: Aug. 29, 2016

Related U.S. Application Data
(60) Provisional application No. 62/240,822, filed on Oct. 13, 2015.

(51) Int. Cl. G03G 15/00; G03G 15/04; G03G 21/18

(52) U.S. Cl. CPC G03G 21/1846

(57) ABSTRACT

A replaceable unit for an electrophotographic image forming device according to another example embodiment includes a frame and a handle exposed on a top portion of the frame to allow a user to carry the replaceable unit by holding the handle. The handle is movable between a raised position and a lowered position. A latch positioned on the frame is movable between a latched position and an unlatched position. The handle is operatively connected to the latch such that lifting of the handle from the lowered position to the raised position to carry the replaceable unit moves the latch from the latched position to the unlatched position.

### CROSS REFERENCES TO RELATED APPLICATIONS

This application claims priority to U.S. Provisional Patent Application Ser. No. 62/240,822, filed Oct. 13, 2015, entitled “Integrated Handle and Latch for an Imaging Unit of an Electrophotographic Image Forming Device,” the content of which is hereby incorporated by reference in its entirety.

### BACKGROUND

1. Field of the Disclosure

The present invention relates generally to electrophotographic image forming devices and more particularly to an integrated handle and latch for a replaceable unit of an electrophotographic image forming device.

2. Description of the Related Art

In order to reduce the premature replacement of components traditionally housed within a toner cartridge for an image forming device, toner cartridge manufacturers have begun to separate components having a longer life from those having a shorter life into separate replaceable units. The image forming device's main toner supply, which is consumed relatively quickly, is provided in a large reservoir in a first replaceable unit, which may be referred to as a toner cartridge. Relatively longer life components are provided in one or more additional replaceable units. For example, the developer roll, toner adder roll, doctor blade and a relatively small reservoir of toner (in the case of a single component development image forming device) or the magnetic roll and a relatively small reservoir containing a mix of toner and magnetic carrier beads (in the case of a dual component development image forming device) may be provided in a second replaceable unit, which may be referred to as a developer unit. The photoconductive drum, charge roll and cleaner blade/roll may be provided in a third replaceable unit, which may be referred to as a photoconductor unit. Alternatively, the developer unit and photoconductor unit may be joined in a single replaceable unit. This configuration allows replenishment of the image forming device's toner supply without replacing the developer unit or photoconductor unit. This configuration also allows the developer unit and the photoconductor unit to be repaired or replaced independent of the image forming device's main toner supply.

It is desired to permit a user to easily load and unload the replaceable units into and out of the image forming device.

### SUMMARY

A replaceable imaging basket for an electrophotographic image forming device according to one example embodiment includes a frame having a top, a bottom, a front, a rear, a first side and a second side. The frame rotatably supports a plurality of photoconductive drums. Rotational axes of the photoconductive drums extend along a front-to-rear direction of the frame that runs from the front end of the frame to the rear end of the frame. The frame has a plurality of positioning slots that are open at the top of the frame for receiving a corresponding plurality of developer units matable with the plurality of photoconductive drums for transferring toner to the photoconductive drums. A handle is positioned at the first side of the frame. The handle includes a hand grip that is sized to permit a user to carry the imaging basket by holding the hand grip of the handle. The handle is movable between a raised position and a lowered position. A latch is positioned on the frame. The latch is movable between a latched position for restraining the imaging basket in the image forming device and an unlatched position for releasing the imaging basket from the image forming device. The handle is operatively connected to the latch such that lifting of the handle from the lowered position to the raised position moves the latch from the latched position to the unlatched position.

A replaceable unit for an electrophotographic image forming device according to another example embodiment includes a frame configured to support a plurality of photoconductive drums and a corresponding plurality of developer units that transfer toner to the photoconductive drums. A handle on the frame allows a user to carry the replaceable unit by holding the handle. The handle is movable between a raised position and a lowered position. A latch on the frame is movable between a latched position for restraining the replaceable unit in the image forming device and an unlatched position for releasing the replaceable unit from the image forming device. The handle is operatively connected to the latch such that lifting of the handle from the lowered position to the raised position moves the latch from the latched position to the unlatched position.

A replaceable unit for an electrophotographic image forming device according to another example embodiment includes a frame and a handle exposed on a top portion of the frame to allow a user to carry the replaceable unit by holding the handle. The handle is movable between a raised position and a lowered position. A latch positioned on the frame is movable between a latched position and an unlatched position. The handle is operatively connected to the latch such that lifting of the handle from the lowered position to the raised position to carry the replaceable unit moves the latch from the latched position to the unlatched position.

### BRIEF DESCRIPTION OF THE DRAWINGS

The accompanying drawings incorporated in and forming a part of the specification, illustrate several aspects of the present disclosure, and together with the description serve to explain the principles of the present disclosure.

FIG. 1 is a schematic view of the interior of an image forming device according to one example embodiment.

FIG. 2 is a perspective view of an imaging unit according to one example embodiment.

FIGS. 3A and 3B are side elevation views from a first side of the imaging unit of a portion of a side of the imaging unit shown in FIG. 2 showing the imaging unit as it slides out of the image forming device with a latch of the imaging unit in a latched position and an unlatched position, respectively, according to one example embodiment.

FIGS. 4A and 4B are side elevation views of the imaging unit shown in FIGS. 2, 3A and 3B from a second side of the imaging unit showing the latch of the imaging unit in the latched position and the unlatched position, respectively.

FIG. 5 is a perspective view of a prior art imaging unit.

FIGS. 6A and 6B are side elevation views of the prior art imaging unit shown in FIG. 5 showing a latch of the prior art imaging unit in a latched position and an unlatched position, respectively.

### DETAILED DESCRIPTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

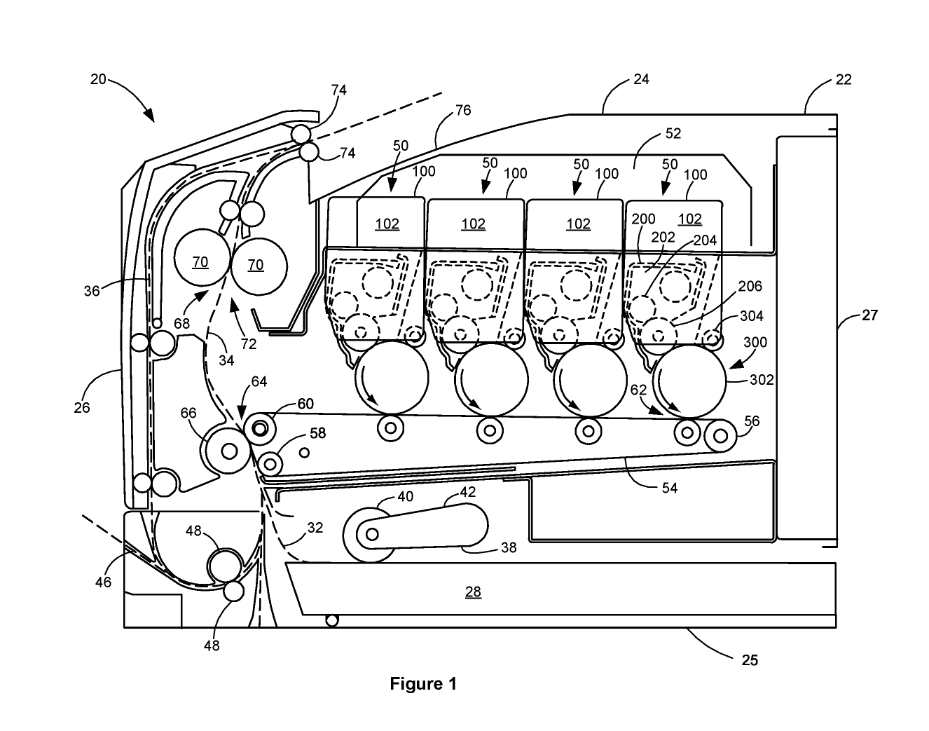

FIG. 1 illustrates a schematic view of the interior of an example image forming device 20. Image forming device 20 includes a housing 22 having a top 24, bottom 25, front 26 and rear 27. Housing 22 includes one or more input trays 28 positioned therein. Trays 28 are sized to contain a stack of media sheets. As used herein, the term media is meant to encompass not only paper but also labels, envelopes, fabrics, photographic paper or any other desired substrate. Trays 28 are preferably removable for refilling. A control panel (not shown) may be located on housing 22. Using the control panel, a user is able to enter commands and generally control the operation of the image forming device 20. For example, the user may enter commands to switch modes (e.g., color mode, monochrome mode), view the number of pages printed, etc. A media path 32 extends through image forming device 20 for moving the media sheets through the image transfer process. Media path 32 includes a simplex path 34 and may include a duplex path 36. A media sheet is introduced into simplex path 34 from tray 28 by a pick mechanism 38. In the example embodiment shown, pick mechanism 38 includes a roll 40 positioned at the end of a pivotable arm 42. Roll 40 rotates to move the media sheet from tray 28 and into media path 32. The media sheet is then moved along media path 32 by various transport rolls. Media sheets may also be introduced into media path 32 by a manual feed 46 having one or more rolls 48.

Image forming device 20 includes an image transfer section that includes one or more imaging stations 50. In the example embodiment illustrated, each imaging station 50 includes a toner cartridge 100, a developer unit 200 and a photoconductor unit 300. Each toner cartridge 100 includes a reservoir 102 for holding toner and an outlet port in communication with an inlet port of a corresponding developer unit 200 for periodically transferring toner from reservoir 102 to developer unit 200 in order to replenish the developer unit 200. One or more agitating members may be positioned within reservoir 102 to aid in moving the toner. In the example embodiment illustrated, image forming device 20 utilizes what is commonly referred to as a single component development system. In this embodiment, each developer unit 200 includes a toner reservoir 202 and a toner adder roll 204 that moves toner from reservoir 202 to a developer roll 206. Each photoconductor unit 300 includes a charge roll 304, a photoconductive (PC) drum 302 and a cleaner blade or roll (not shown). PC drums 302 are mounted substantially parallel to each other. For purposes of clarity, developer unit 200 and photoconductor unit 300 are labeled on only one of the imaging stations 50. Each imaging station 50 may be substantially the same except for the color of toner used.

Each charge roll 304 forms a nip with the corresponding PC drum 302. During a print operation, charge roll 304 charges the surface of PC drum 302 to a specified voltage such as, for example, −1000 volts. A laser beam from a printhead 52 associated with each imaging station 50 is then directed to the surface of PC drum 302 and selectively discharges those areas it contacts to form a latent image on the surface of PC drum 302. In one embodiment, areas on PC drum 302 illuminated by the laser beam are discharged to approximately −300 volts. Developer roll 206, which forms a nip with the corresponding PC drum 302, then transfers toner to the latent image on the surface of PC drum 302 to form a toner image. The toner is attracted to the areas of PC drum 302 surface discharged by the laser beam from the printhead 52. A metering device, such as a doctor blade, can be used to meter toner onto developer roll 206 and apply a desired charge on the toner prior to its transfer to PC drum 302.

An intermediate transfer mechanism (ITM) 54 is disposed adjacent to the imaging stations 50. In this embodiment, ITM 54 is formed as an endless belt trained about a drive roll 56, a tension roll 58 and a back-up roll 60. During image forming operations, ITM 54 moves past imaging stations 50 in a clockwise direction as viewed in FIG. 1. One or more of PC drums 302 apply toner images in their respective colors to ITM 54 at a first transfer nip 62. In one embodiment, a positive voltage field attracts the toner image from PC drums 302 to the surface of the moving ITM 54. ITM 54 rotates and collects the one or more toner images from imaging stations 50 and then conveys the toner images to a media sheet at a second transfer nip 64 formed between a transfer roll 66 and ITM 54, which is supported by back-up roll 60. The cleaner blade/roll of each photoconductor unit 300 removes any toner remnants on PC drum 302 so that the surface of PC drum 302 may be charged and developed with toner again.

A media sheet advancing through simplex path 34 receives the toner image from ITM 54 as it moves through the second transfer nip 64. The media sheet with the toner image is then moved along the media path 32 and into a fuser area 68. Fuser area 68 includes fusing rolls or belts 70 that form a nip 72 to adhere the toner image to the media sheet. The fused media sheet then passes through exit rolls 74 that are located downstream from the fuser area 68. Exit rolls 74 may be rotated in either forward or reverse directions. In a forward direction, exit rolls 74 move the media sheet from simplex path 34 to an output area 76 on top 24 of image forming device 20. In a reverse direction, exit rolls 74 move the media sheet into duplex path 36 for image formation on a second side of the media sheet.

While the example image forming device 20 shown in FIG. 1 utilizes ITM 54 to transfer toner to the media, toner may be applied directly to the media by the one or more PC drums 302 as is known in the art. Further, while the example image forming device 20 shown in FIG. 1 utilizes a single component development system, in another embodiment, image forming device 20 utilizes what is commonly referred to as a dual component development system. In this embodiment, reservoir 202 of developer unit 200 stores a mixture of toner and magnetic carrier beads. The carrier beads may be coated with a polymeric film to provide triboelectric properties to attract toner to the carrier beads as the toner and the carrier beads are mixed in reservoir 202. Each developer unit 200 also includes a magnetic roll that attracts the carrier beads in reservoir 202 having toner thereon to the magnetic roll through the use of magnetic fields and transports the toner to the corresponding PC drum 302. Electrostatic forces from the latent image on PC drum 302 strip the toner from the carrier beads to form a toner image on the surface of PC drum 302. PC drum 302 is charged by charge roll 304 and cleaned by a cleaner blade/roll as discussed above.

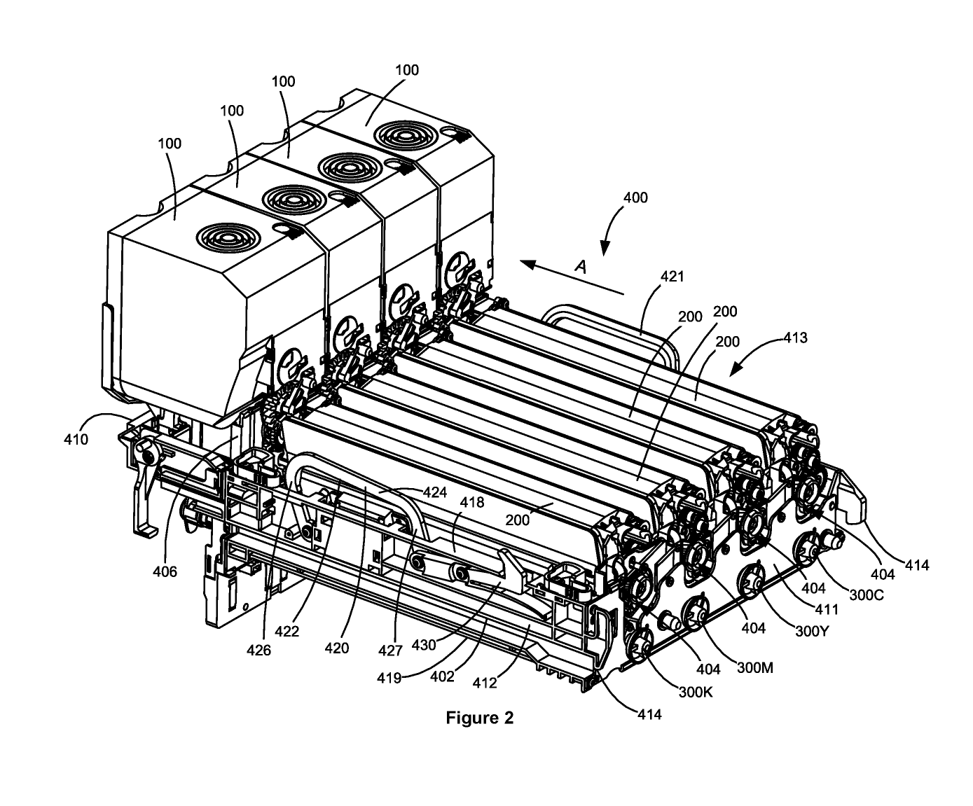

With reference to FIG. 2, image forming device 20 includes an imaging basket or unit 400 that holds imaging stations 50. Imaging unit 400 is removably installable in image forming device 20. Imaging unit 400 includes a frame 402 that supports the components of imaging stations 50. In the embodiment illustrated, frame 402 includes four positioning slots 404 that each hold a respective developer unit 200 and photoconductor unit 300 (positioned underneath each developer unit 200 as viewed in FIG. 2). In one embodiment, each developer unit 200 is individually removable from imaging unit 400 and each photoconductor unit 300 is fixed to imaging unit 400. In another embodiment, the photoconductor unit 300K on the far left as viewed in FIG. 2, which forms part of the black toner imaging station 50, is removable from imaging unit 400 while the remaining three photoconductor units 300M, 300Y, 300C, which form part of the colored toner (e.g., magenta, yellow, cyan) imaging stations 50, are fixed to imaging unit 400. This configuration permits replacement of the black photoconductor unit 300K separate from the colored photoconductor units 300M, 300Y, 300C in the event that the black photoconductor unit 300K requires replacement more frequently than the colored photoconductor units 300M, 300Y, 300C due to higher consumption of black toner than colored toner. In other embodiments, all or a subset of colored photoconductor units 300M, 300Y, 300C may be individually removable from imaging basket 400 as desired. For example, in another embodiment, all four photoconductor units 300 are individually removable from imaging unit 400. Where one or more of photoconductor units 300 is removable from imaging unit 400, the photoconductor unit 300 may be fixed to its corresponding developer unit 200 or separable therefrom. In another embodiment, developer units 200 and photoconductor units 300 are fixed to imaging unit 400. In the example embodiment illustrated, imaging unit 400 also includes four cradles 406 that each hold a respective toner cartridge 100. In this embodiment, each toner cartridge 100 is individually removable from imaging unit 400, separate from developer units 200 and photoconductor units 300.

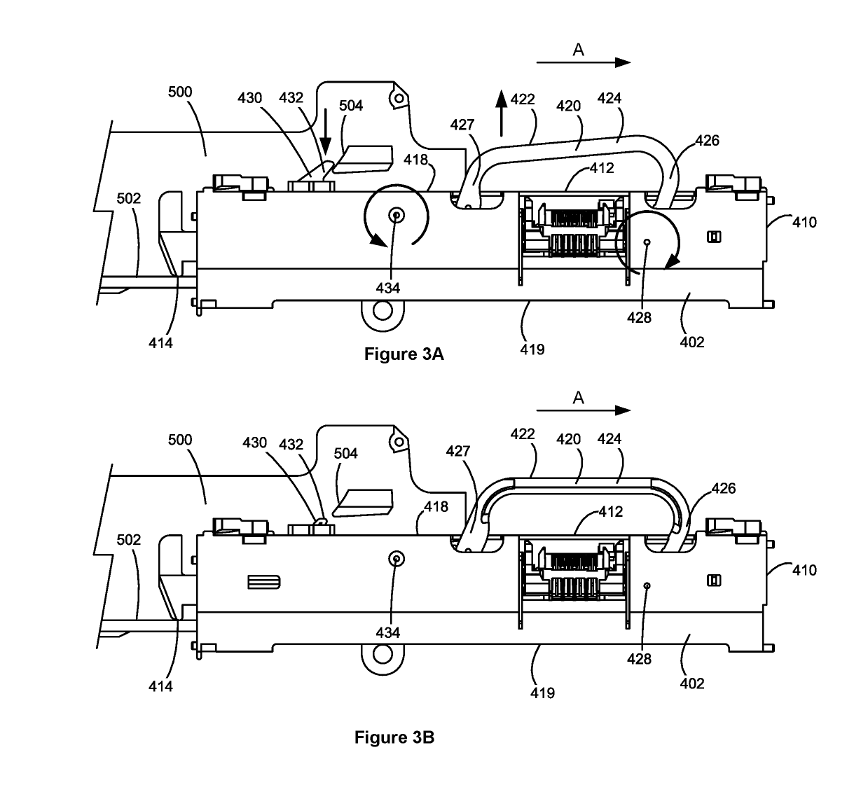

Frame 402 includes a front end 410, a rear end 411, a pair of sides 412, 413, a top 418 and a bottom 419. Positioning slots 404 are open at the top 418 of frame 402 to permit removal and insertion of the replaceable developer units 200 and photoconductor units 300. In the embodiment illustrated, imaging unit 400 slides into and out of image forming device 20. Front end 410 of frame 402 leads as imaging unit 400 slides out of image forming device 20 in the direction indicated by arrow A and rear end 411 trails. Conversely, rear end 411 of frame 402 leads as imaging unit 400 slides into image forming device 20 and front end 410 trails. Each side 412, 413 of frame 402 includes a rail 414 that rides on a corresponding ledge in image forming device 20 that supports imaging unit 400 and guides the sliding motion of imaging unit 400. For example, FIGS. 3A and 3B show an inner portion of side 412 of frame 402 as imaging unit 400 is slid out of image forming device 20 in the direction indicated by arrow A. FIGS. 3A and 3B show a frame 500 of image forming device 20 that is positioned next to side 412 of frame 402 when imaging unit 400 is installed in image forming device 400. Rail 414 on side 412 of frame 402 rides on a corresponding ledge 502 on the inner side of frame 500.

With reference back to FIG. 2, in the example embodiment illustrated, the rotational axes of PC drums 302 and developer rolls 206 run from front end 410 to rear end 411, substantially parallel to sides 412, 413. However, this configuration may be rotated by ninety degrees such that the rotational axes of PC drums 302 and developer rolls 206 run from side 412 to side 413 as desired. In the example embodiment illustrated, cradles 406 are positioned at front end 410 of frame 402; however, cradles 406 may be positioned at any suitable location on frame 402 such as, for example, rear end 411.

Imaging unit 400 also includes a handle 420, 421 at each side 412, 413 of frame 402 roughly midway between front end 410 and rear end 411 of frame 402. In the embodiment illustrated, each handle 420, 421 is positioned at top 418 of frame 402. In other embodiments, each handle 420, 421 is positioned on a respective side 412, 413 of frame 402 between top 418 and bottom 419 of frame 402. In the example embodiment illustrated, each handle 420, 421 includes a looped member 422 (similar to, e.g., a briefcase handle) that extends upward from the top 418 of frame 402. Looped member 422 includes a hand grip segment 424 and two connecting segments 426, 427 that extend downward from hand grip segment 424 toward frame 402 and join looped member 422 to frame 402. However, handles 420, 421 are not limited to the example embodiment illustrated and may take any suitable shape or structure. Handle 420 is movable up and down between a raised position and a lowered position such that lifting of handle 420 upward toward the raised position releases a latch of imaging unit 400 as discussed in greater detail below.

To remove imaging unit 400 from image forming device 20, a user first holds front end 410 of frame 402 and pulls imaging unit 400 from image forming device 20 in the direction indicated by arrow A. As shown in FIGS. 3A and 3B, a catch 504 in image forming device 20 is positioned to contact a latch 430 on imaging unit 400 during removal of imaging unit 400 from image forming device 20. Catch 504 is positioned to contact latch 430 on imaging unit 400 when imaging unit 400 is partially removed from image forming device 20 with handles 420, 421 exposed to the user. The engagement between catch 504 and latch 430 prevents imaging unit 400 from falling out of image forming device 20 before the user is able to securely grasp imaging unit 400. Latch 430 is movable between a latched position shown in FIG. 3A and an unlatched position shown in FIG. 3B. In the latched position of latch 430, a head 432 of latch 430 is positioned to contact catch 504 as imaging unit 400 is slid out of image forming device 20. In the embodiment illustrated, in the latched position of latch 430, head 432 protrudes upward from the top 418 of frame 402. In the unlatched position, head 432 of latch 430 is clear of catch 504 permitting removal of imaging unit 400 from image forming device 20. In the embodiment illustrated, in the unlatched position of latch 430, head 432 is partially retracted into the top 418 of frame 402. Handle 420 is operatively connected to latch 430 such that the lifting of handle 420 moves latch 430 from its latched position to its unlatched position. Accordingly, to release imaging unit 400 from image forming device 20 and complete the removal of imaging unit 400 from image forming device 20, the user lifts up on handle 420 to move latch 430 clear of catch 504 allowing the user to use handles 420, 421 to pull imaging unit 400 completely out of image forming device 20 and to carry imaging unit 400. In this manner, the user is able to unlatch and remove imaging unit 400 from image forming device 20 through one simple, natural lifting motion as a result of the interoperation of handle 420 with latch 430.

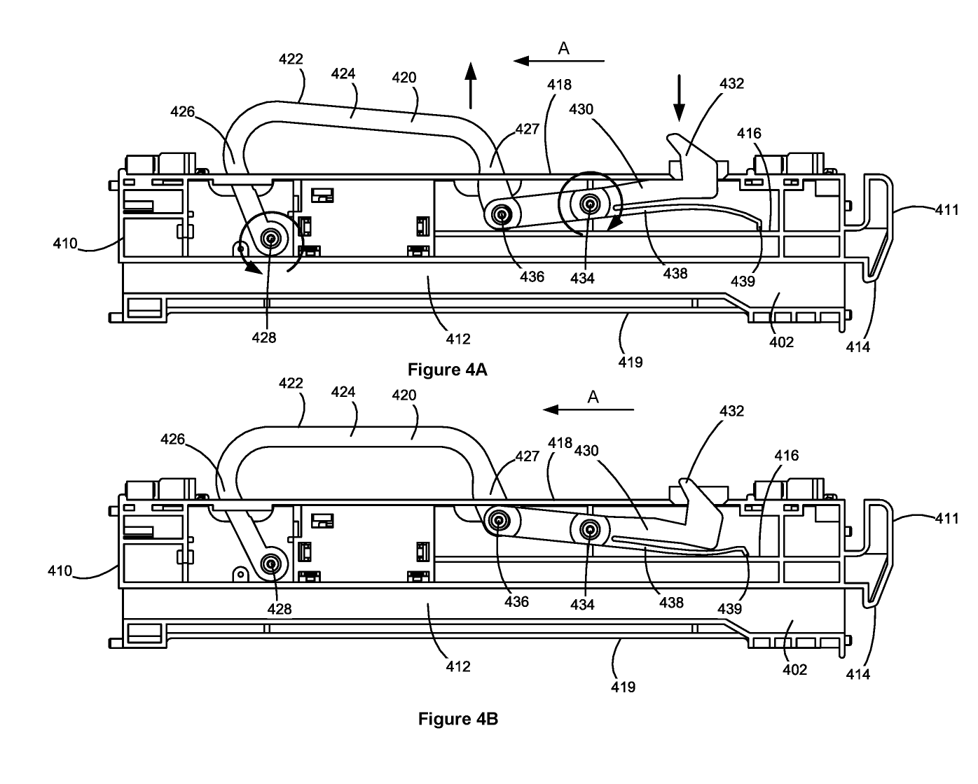

With reference to FIGS. 4A and 4B, in the embodiment illustrated, handle 420 is pivotable about a fixed pivot point 428 and latch 430 is pivotable about a fixed pivot point 434. In this embodiment, handle 420 is pivotally connected to latch 430 about a pivot point 436 allowing latch 430 to pivot relative to handle 420 as handle 420 is raised and lowered. Latch 430 is biased toward the latched position shown in FIG. 4A by a biasing member. In the embodiment illustrated, handle 420 is biased toward a lowered position shown in FIG. 4A by the biasing member as a result of the connection of latch 430 to handle 420. In the embodiment illustrated, the biasing member includes a resilient bias arm 438 extending in a cantilevered manner from latch 430. A free end 439 of bias arm 438 is positioned against a ledge 416 on side 412 of frame 402. However, the biasing member is not limited to bias arm 438. Rather, any suitable biasing member may be used as desired, such as, for example, a torsion spring, a compression spring, a leaf spring, an extension spring or a material having resilient properties. In the embodiment illustrated, when latch 430 is in its latched position and handle 420 is in its lowered position as shown in FIG. 4A, hand grip segment 424 of handle 420 is mostly horizontal but angled relative to top 418 of frame 402 and to the rotational axes of PC drums 302 of photoconductor units 300.

With reference to FIGS. 3A, 3B, 4A and 4B, when the user lifts handle 420, handle 420 pivots counterclockwise as viewed in FIGS. 4A and 4B (clockwise as viewed in FIGS. 3A and 3B) about pivot point 428 from its lowered position shown in FIGS. 3A and 4A to its raised position shown in FIGS. 3B and 4B causing latch 430 to pivot clockwise as viewed in FIGS. 4A and 4B (counterclockwise as viewed in FIGS. 3A and 3B) about pivot point 434 and latch 430 to move from its latched position shown in FIGS. 3A and 4A to its unlatched position shown in FIGS. 3B and 4B against the bias applied to latch 430 by bias arm 438. The movement of latch 430 from its latched position to its unlatched position causes bias arm 438 to flex against ledge 416. When latch 430 is in its unlatched position, to head 432 of latch 430 is lowered and positioned clear of catch 504 allowing the user to remove imaging unit 400 from image forming device 20 as discussed above. In the embodiment illustrated, when latch 430 is in its unlatched position and handle 420 is in its raised position as shown in FIG. 4B, hand grip segment 424 of handle 420 is substantially horizontal relative to top 418 of frame 402 and substantially parallel to the rotational axes of PC drums 302 of photoconductor units 300. When the user releases handle 420, the bias applied to latch 430 causes latch 430 to return to its latched position, in turn, causing handle 420 to return to the lowered position of handle 420 shown in FIGS. 3A and 4A.

It will be appreciated that the configurations of handle 420 and latch 430 are not limited to the example embodiments illustrated. For example, in other embodiments, the orientation of latch 430 is reversed such that latch 430 moves upward toward the unlatched position and downward toward the latched position. Similarly, in other embodiments, latch 430 moves toward and away from sides 412, 413 when moving between the latched and unlatched positions. In some embodiments, latch 430 translates between the latched and unlatched positions instead of pivoting. Similarly, in some embodiments, handle 420 translates upward to unlatch latch 430 and downward to return latch 430 to the latched position. Further, latch 430 and/or handle 420 may pivot about a floating pivot point instead of fixed pivot points 434 and 428.

Handle 421 may be configured substantially the same as handle 420 and may actuate a latch similar to latch 430 in order to release imaging unit 400 from image forming device 20. Alternatively, handle 421 may simply provide a hand grip to assist the user in lifting imaging unit 400 without providing unlatching functionality.

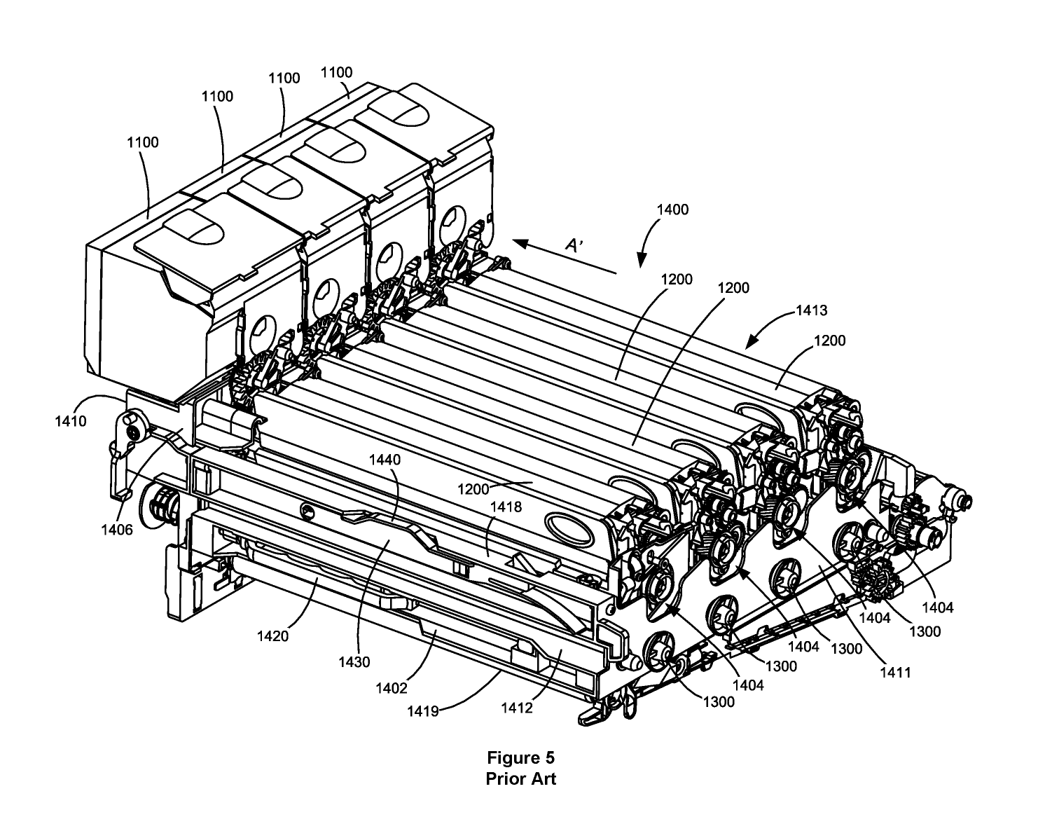

FIG. 5 shows a prior art imaging unit 1400. Imaging unit 1400 is removably installable in an image forming device and includes a frame 1402. Frame 1402 includes four positioning slots 1404 that each hold a respective developer unit 1200 and photoconductor unit 1300. Each developer unit 1200 is individually removable from imaging unit 1400 and each photoconductor unit 1300 is fixed to imaging unit 1400. Imaging unit 1400 also includes four cradles 1406 that each hold a respective toner cartridge 1100.

Frame 1402 includes a front end 1410, a rear end 1411, a pair of sides 1412, 1413, a top 1418 and a bottom 1419. Imaging unit 1400 slides into and out of its image forming device. Front end 1410 of frame 1402 leads as imaging unit 1400 slides out of the image forming device in the direction indicated by arrow A′ and rear end 1411 trails.

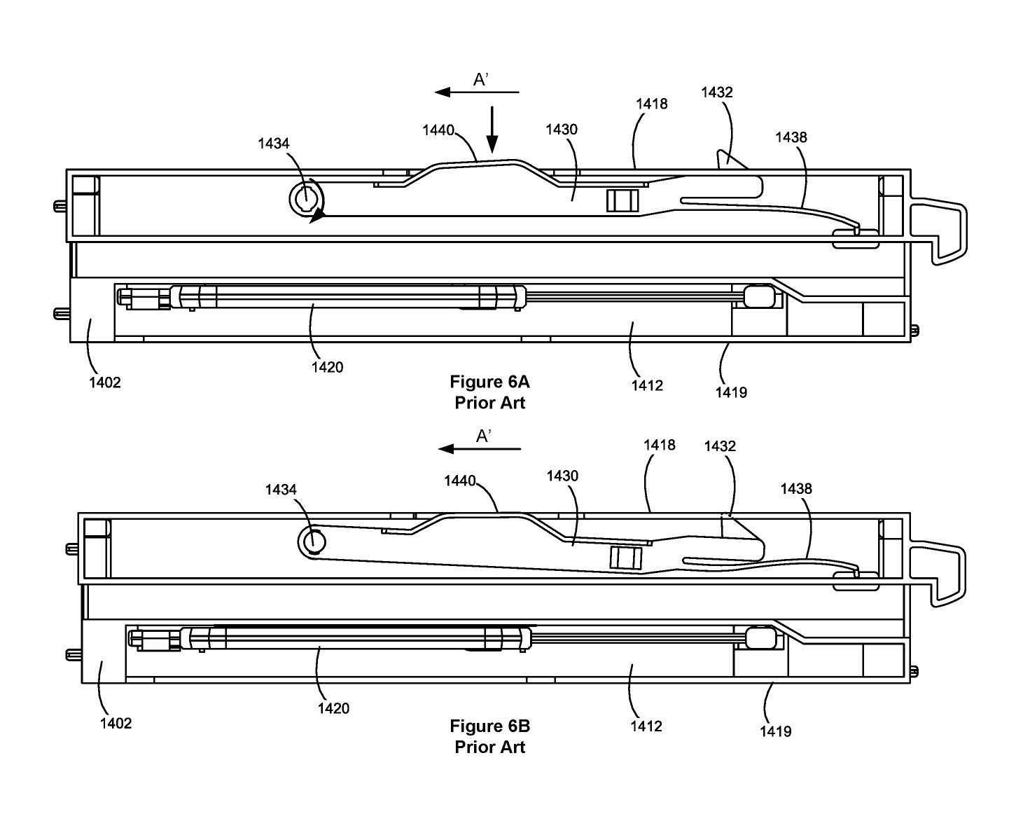

With reference to FIGS. 5, 6A and 6B, a handle 1420 is positioned on side 1412 of frame 1402. Handle 1420 is fixedly positioned on frame 1420 and extends outward sideways from side 1412 of frame 1420, near the bottom of frame 1420. A latch 1430 is positioned on side 1412 of frame 1402. Latch 1430 is pivotable about a fixed pivot point 1434. Latch 1430 is movable between a latched position shown in FIG. 6A and an unlatched position shown in FIG. 6B. Latch 1430 includes a head 1432 that is positioned to contact a corresponding catch in the image forming device when latch 1430 is in its latched position during removal of imaging unit 1400 in the direction indicated by arrow A′. Latch 1430 also includes an engagement surface 1440 positioned on a top portion of latch 1430. Latch 1430 is biased toward its latched position by a bias arm 1438 similar to bias arm 438 discussed above. To release imaging unit 1400 from the image forming device and remove imaging unit 1400 from the image forming device, the user wraps his or her non-thumb fingers around and under handle 1420 and presses downward on engagement surface 1440 with his or her thumb. The downward force on latch 1430 overcomes the bias applied by bias arm 1438 causing latch 1430 to pivot clockwise about pivot point 1434 as viewed in FIGS. 6A and 6B from its latched position to its unlatched position unlatching imaging unit 1400 from the image forming device. The user is then able to carry imaging unit 1400 by handle 1420 and a similar handle on the opposite side of frame 1402.

The integrated handle 420 and latch 430 of the present disclosure simplifies the unlatching and removal of imaging unit 400. As discussed above, the user is able to unlatch and remove imaging unit 400 from image forming device 20 through a single lifting motion as a result of the interoperation of handle 420 with latch 430. In contrast, prior art imaging unit 1400 requires the user to simultaneously and separately lift handle 1420 and depress latch 1430 using one hand. Further, in the example embodiment illustrated, handle 420 of the present disclosure is more accessible and easier for the user to locate than handle 1420 and engagement surface 1440 of latch 1430 since handle 420 is presented clearly on top 418 of frame 402 instead of off the side of frame 1402 like handle 1420 or recessed in the top 1418 of frame 1402 like latch 1430. The location of handle 420 and its interoperation with latch 430 allow a user who is not experienced in handling imaging unit 400 to intuitively locate handle 420 and quickly unlatch imaging unit 400 simply by lifting imaging unit 400 using handle 420. The location of handle 420 also reduces the risk of the user accidentally touching the surfaces of PC drums 302, which are particularly sensitive to user contact, held by frame 402 and exposed on the bottom 419 of frame 402. In contrast, the user may tend to inadvertently touch the surface of one or more of the PC drums of imaging unit 1400 when reaching for handle 1420 due to the position of handle 1420 near the bottom 1419 of frame 1402 and the need for the user to wrap his or her fingers around and under handle 1420.

While the example embodiments illustrated include an integrated handle and latch positioned on an imaging basket of a multicolor image forming device, it will be appreciated that such an integrated handle and latch may be positioned on other replaceable units of an electrophotographic image forming device in order to allow a user to unlatch and remove the replaceable unit from the image forming device. For example, an integrated handle and latch may be positioned on an imaging unit of a monocolor imaging forming device, a fuser, a replaceable intermediate transfer mechanism, etc.

The foregoing description illustrates various aspects of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

1. A replaceable imaging basket for an electrophotographic image forming device, comprising:
a frame having a top, a bottom, a front, a rear, a first side and a second side, the frame rotatably supports a plurality of photoconductive drums, rotational axes of the photoconductive drums extend along a front-to-rear direction of the frame that runs from the front end of the frame to the rear end of the frame, the frame has a plurality of positioning slots that are open at the top of the frame for receiving a corresponding plurality of developer units matable with the plurality of photoconductive drums for transferring toner to the photoconductive drums;
a handle positioned at the first side of the frame, the handle includes a hand grip that is sized to permit a user to carry the imaging basket by holding the hand grip of the handle, the handle is movable between a raised position and a lowered position; and
a latch positioned on the frame that is movable between a latched position for restraining the imaging basket in the image forming device and an unlatched position for releasing the imaging basket from the image forming device,
wherein the handle is operatively connected to the latch such that lifting of the handle from the lowered position to the raised position moves the latch from the latched position to the unlatched position.

2. The replaceable imaging basket of claim 1, wherein the handle extends upward from the top of the frame.

3. The replaceable imaging basket of claim 1, wherein the handle is pivotable between the raised position and the lowered position.

4. The replaceable imaging basket of claim 1, wherein the handle is biased toward the lowered position.

5. The replaceable imaging basket of claim 1, wherein, in the latched position of the latch, a head of the latch protrudes upward from the top of the frame.

6. The replaceable imaging basket of claim 1, wherein the latch is pivotable between the latched position and the unlatched position.

7. The replaceable imaging basket of claim 1, wherein the latch is biased toward the latched position.

8. The replaceable imaging basket of claim 1, further comprising a second handle positioned at the second side of the frame, the second handle includes a second hand grip that is sized to permit a user to carry the imaging basket by holding the first and second hand grips of the first and second handles.

9. The replaceable imaging basket of claim 1, wherein, in the raised position of the handle, the hand grip of the handle is positioned horizontal with respect to the top of the frame.

10. A replaceable unit for an electrophotographic image forming device, comprising:
a frame configured to support a plurality of photoconductive drums and a corresponding plurality of developer units that transfer toner to the photoconductive drums;
a handle on the frame that allows a user to carry the replaceable unit by holding the handle, the handle is movable between a raised position and a lowered position; and
a latch on the frame that is movable between a latched position for restraining the replaceable unit in the image forming device and an unlatched position for releasing the replaceable unit from the image forming device,
wherein the handle is operatively connected to the latch such that lifting of the handle from the lowered position to the raised position moves the latch from the latched position to the unlatched position.

11. The replaceable unit of claim 10, wherein the handle is pivotable between the raised position and the lowered position.

12. The replaceable unit of claim 10, wherein the handle is biased toward the lowered position.

13. The replaceable unit of claim 10, wherein the latch is pivotable between the latched position and the unlatched position.

14. The replaceable unit of claim 10, wherein the latch is biased toward the latched position.

15. A replaceable unit for an electrophotographic image forming device, comprising:
a frame;
a handle exposed on a top portion of the frame to allow a user to carry the replaceable unit by holding the handle, the handle is movable between a raised position and a lowered position; and
a latch positioned on the frame that is movable between a latched position and an unlatched position,
wherein the handle is operatively connected to the latch such that lifting of the handle from the lowered position to the raised position to carry the replaceable unit moves the latch from the latched position to the unlatched position.

16. The replaceable unit of claim 15, wherein the handle is pivotable between the raised position and the lowered position.

17. The replaceable unit of claim 15, wherein the handle is biased toward the lowered position.

18. The replaceable unit of claim 15, wherein the latch is pivotable between the latched position and the unlatched position.

19. The replaceable unit of claim 15, wherein the latch is biased toward the latched position.
